(19) United States
(12) Patent Application Publication
(10) Pub. No.: US 2024/0005896 A1
(43) Pub. Date: Jan. 4, 2024

(54) MUSIC GENERATION METHOD AND APPARATUS

(71) Applicant: Creativemind Inc., Seoul (KR)

(72) Inventors: Jong Hyun LEE, Seoul (KR); Jae Hun JEONG, Seoul (KR)

(21) Appl. No.: 18/343,853

(22) Filed: Jun. 29, 2023

(30) Foreign Application Priority Data
Jun. 30, 2022 (KR) 10-2022-0080716

(51) Int. Cl. G10H 1/00

(52) U.S. Cl. CPC G10H 1/0066; G10H 1/0025; G10H 2210/331; G10H 2210/086

(57) ABSTRACT

A method of generating music and a music generation apparatus are disclosed. The music generation apparatus generates a musical score from audio samples, selects, from among a plurality of MIDI samples, a MIDI sample suitable for the musical score based on a position of a note on a time axis, adjusts pitches of notes of each measure of the selected MIDI sample to match the component notes and tonality of each measure of the musical score, and outputs a melody sample in which the pitches of the notes are adjusted.

### CROSS-REFERENCE TO RELATED APPLICATION

This application is based on and claims priority under 35 U.S.C. § 119 to Korean Patent Application No. 10-2022-0080716, filed on Jun. 30, 2022, in the Korean Intellectual Property Office, the disclosure of which is incorporated by reference herein in its entirety.

### BACKGROUND

### 1. Field

The present disclosure relates to a method and apparatus for generating music, and more particularly, to a method and apparatus for generating music by using musical instrument digital interface (MIDI) samples and audio samples.

### 2. Description of the Related Art

A musical instrument digital interface (MIDI) file is a digital sound file created by using a computer. Music composed using a MIDI is easy to edit or synthesize on a computer. Composers do not compose music only with an MIDI device, but also play and record music on general instruments. For example, an accompaniment may be composed by directly playing a piano and a melody may be composed by using a MIDI device. However, a file of a general audio format (for example, a file with a way extension, etc.) in which a piano play is recorded may not be directly input to a MIDI device. In order to use a file of an audio format for MIDI composition, it is necessary for a composer to individually input a musical score to a MIDI device while listening to audio format music or convert an audio format file into a file format suitable for a MIDI device.

### SUMMARY

Provided is a method and apparatus for generating music by automatically combining audio samples and MIDI samples.

Additional aspects will be set forth in part in the description which follows and, in part, will be apparent from the description, or may be learned by practice of the presented embodiments of the disclosure.

According to an aspect of the disclosure, a method of generating music, the method includes making a musical score from an audio sample, selecting, from among a plurality of MIDI samples, a musical instrument digital interface (MIDI) sample suitable for the musical score based on a position of a note on a time axis, adjusting pitches of notes of each measure of the selected MIDI sample to match the component notes and tonality of each measure of the musical score, and outputting a melody sample in which the pitches of the notes are adjusted.

According to an aspect of the disclosure, a music generation apparatus includes a transcription unit configured to create a musical score from an audio sample, a MIDI selector configured to select, from among a plurality of MIDI samples, a MIDI sample suitable for the musical score based on a position of a time axis of a component note, a melody generator configured to adjust a pitch of notes of each measure of the selected MIDI sample to match the component note and tonality of each measure of the musical score, and an output unit configured to output a melody sample in which the pitch of the note is adjusted.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing an example of a music generation apparatus according to an embodiment;

FIG. 2 is a diagram illustrating an example of a music generation method according to an embodiment;

FIGS. 3 and 4 are flowcharts illustrating an example of a method of generating a musical score from audio samples according to an embodiment;

FIG. 5 is a diagram showing an example of a method of selecting a MIDI sample suitable for an audio sample according to an embodiment;

FIGS. 6 and 7 are diagrams showing an example of a method of generating a melody sample by adjusting a pitch of a MIDI sample according to an embodiment;

FIG. 8 is a flowchart illustrating an example of a method of generating music according to an embodiment; and

FIG. 9 is a diagram showing a configuration of a music generation apparatus according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a method and apparatus for generating music, according to an embodiment will be described in detail with reference to the accompanying drawings.

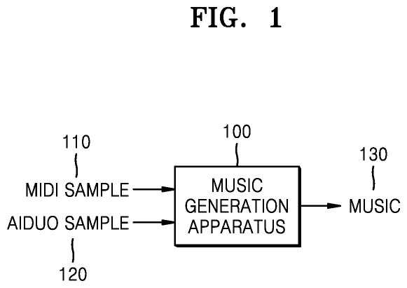

FIG. 1 is a diagram showing an example of a music generation apparatus 100 according to an embodiment.

Referring to FIG. 1, when the music generation apparatus 100 receives a musical instrument digital interface (MIDI) sample 110 and an audio sample 120, the music generation apparatus 100 selects a MIDI sample suitable for the audio sample 120 and generates music 130 by adjusting the MIDI sample to match to the audio sample 120.

The MIDI sample 110 is music data formed in a MIDI format. The MIDI sample 110 is composed of at least one measure, and a plurality of MIDI samples 110 may exist. For example, the plurality of MIDI samples 110 composed of 4 measures may exist. The number of measures of the MIDI sample 110 may vary according to embodiments.

The audio sample 120 is music data formed in an audio format (e.g., a file with a way extension). Because the audio sample 120 is not in a MIDI format, the audio sample 120 is data that may not be input to a MIDI device as it is. For example, an audio file recorded by directly playing a piano may be an audio sample according to the present embodiment. The audio sample 120 may be composed of at least one measure.

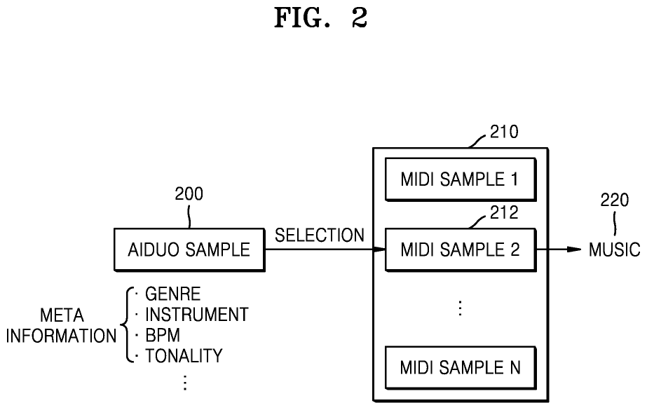

FIG. 2 is a diagram illustrating an example of a music generation method according to an embodiment.

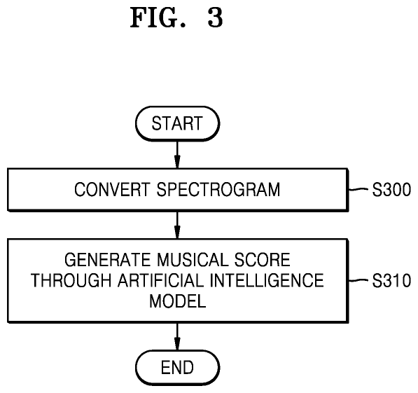

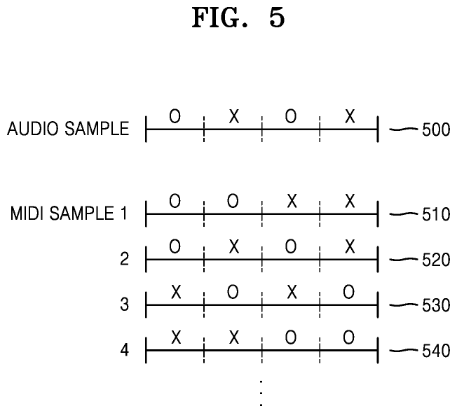

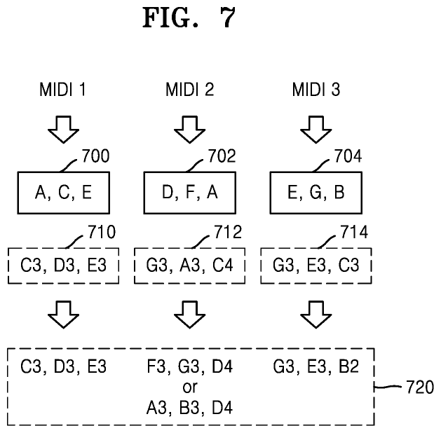

Referring to FIG. 2, the music generating apparatus 100 selects a MIDI sample 212 suitable for an audio sample 200 from among a plurality of MIDI samples 210. The music generation apparatus 100 may select the MIDI sample 212 to be combined with the audio sample 200 based on a rhythm. The music generating apparatus 100 may generate a musical score from the audio sample 200 and compare the musical score of the audio sample 200 and the musical score of the plurality of MIDI samples 210 to identify whether rhythms are similar or not. Because the audio sample 200 is an audio file, a process of generating a musical score from the audio sample 200 is required. An example of a method of generating a musical score from audio samples 200 is shown in FIG. 3. An example of a method of identifying a MIDI sample 212 corresponding to the audio sample 200 based on similarity of rhythm is shown in FIG. 5. When the MIDI sample 212 is selected, the music generation apparatus 100 generates music 220 by adjusting a pitch of each note of the MIDI sample 212. An example of a method of adjusting the pitch of each note of the MIDI sample 212 is shown in FIG. 7.

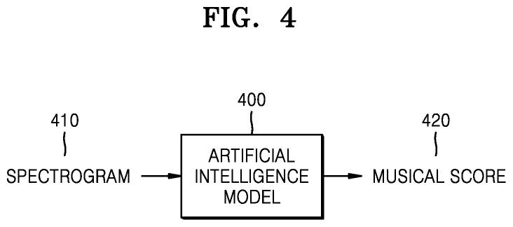

FIGS. 3 and 4 are diagrams illustrating an example of a method for generating a musical score from an audio sample according to an embodiment.

Referring to FIGS. 3 and 4 together, the music generation apparatus 100 obtains a spectrogram of an audio sample (S300). The spectrogram is a tool for visually identifying sound or waves and appears as a combination of a waveform and a spectrum characteristic. Because the method of converting a sound of an audio sample into a spectrogram is already widely known, an additional description thereof will be omitted.

The music generation apparatus 100 generates a musical score for the audio sample through an artificial intelligence model 400 (S310). Here, the artificial intelligence model 400 is a model that outputs a musical score 420 when a spectrogram 410 is input as shown in FIG. 4. The artificial intelligence model 400 may be implemented with various conventional artificial neural networks (RNN, LSTM, etc.). The artificial intelligence model 400 is generated by training using learning data configured of spectrograms for various musical scores. For example, the artificial intelligence model 400 may be trained by using a supervised learning method using learning data in which a spectrogram is labeled as a musical score. Because the method of learning and generating the artificial intelligence model 400 itself is already widely known technology, additional description thereof will be omitted.

The present embodiment proposes a method of using an artificial intelligence model as an example of a method of generating a musical score from an audio sample, but this is only an example, and the present disclosure is not limited thereto. Various conventional transcription methods may be applied to the present embodiment.

FIG. 5 is a diagram showing an example of a method of selecting a MIDI sample suitable for an audio sample according to an embodiment.

Referring to FIG. 5, the music generation apparatus 100 divides each measure of an audio sample 500 into a plurality of sections along the time axis. Although the present embodiment shows that one measure of an audio sample is divided into four sections as an example for better understanding, one measure may be divided into various numbers such as 16 or 32 sections. The music generation apparatus 100 divides the plurality of MIDI samples 510, 520, 530, and 540 into the same section as the audio sample 500. The present embodiment shows that, as an example, a plurality of MIDI samples 510, 520, 530, and 540 are divided into four sections according to the audio sample 500.

The music generation apparatus 100 may identify whether the rhythm of the audio sample 500 and the rhythms of the MIDI samples 510, 520, 530, and 540 are similar to each other or not based on whether sections in which notes are positioned in a measure are similar to each other. For example, in the audio sample 500, notes exist in the first and third sections. A section in which notes exist is indicated by ‘O’, and a section in which no note exists is indicated by ‘X’. The first MIDI sample 510 has notes in the first and second sections, and the second MIDI sample 520 has notes in the first and third sections. The second MIDI sample 520 is the same MIDI sample having a position of the notes on the time axis as the audio sample 500. Accordingly, the music generation apparatus 100 may select the second MIDI sample 520 as a MIDI sample having positions most similar to the positions of the notes on the time axis of the audio sample 500. If a plurality of MIDI samples having notes at the same positions as the positions of the notes on the time axis of the audio sample 500 are identified, the music generation apparatus 100 may select an arbitrary MIDI sample from among the plurality of MIDI samples. In the case when the audio sample is an accompaniment part and the MIDI sample is a melody part, powerful music is completed by selecting the MIDI sample having the most similar positional relationship between the audio sample and the musical note.

On the other hand, when soft and melodic music is required, it is better to connect notes of MIDI sample between the notes of the audio sample. To this end, the music generation apparatus 100 may select a MIDI sample having a note at a position different from that of the note in the audio sample 500. For example, because notes exist in the first and third measures in the audio sample 500 and notes exist in the second and fourth sections in the third MIDI sample 530, the positions of the notes between the audio sample 500 and the third MIDI sample 530 are staggered to each other. That is, the notes of the third MIDI sample 530 are positioned where the performance is resting in the audio sample 500. Accordingly, the music generation apparatus 100 may select the third MIDI sample 530 as a MIDI sample suitable for the audio sample 500.

Whether to select a MIDI sample 520 that matches the positions of the notes of the audio sample 500 or select the MIDI sample 530 having notes where the performance of the audio sample 500 rests (that is, where the notes of the audio sample are not located) may be performed in advance by the user or the like on the music generation apparatus 100.

The present embodiment shows an example of selecting a MIDI sample based on one measure. However, if the audio sample and the MIDI sample each configured of four measures, a MIDI sample suitable for an audio sample may be identified by comparing the positions of notes on the time axis based on all four measures.

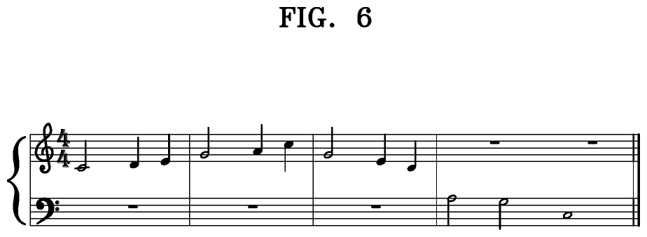

FIGS. 6 and 7 are diagrams illustrating an example of a method of generating a melody sample by adjusting a pitch of a MIDI sample according to an embodiment.

Referring to FIGS. 6 and 7, the music generation apparatus 100 identifies component notes 700, 702, and 704 of each measure of an audio sample based on a musical score of the audio sample. For example, in the present embodiment, it is assumed that the component notes 700 of the first measure of the audio sample are A, C, and E, the component notes 702 of the second measure are D, F, and A, and the component notes 704 of the third measure are E, G, and B.

The music generation apparatus 100 adjusts a pitch of notes of each measure of the selected MIDI sample (FIG. 6) based on the component notes and tonality of the audio sample. Here, the tonality may exist in meta information of the audio sample or may be input separately. If the tonality of the audio sample is A minor, scale sounds are A, B, C, D, E, F, G, and A, which are musical scales constituting the corresponding tonality. Hereinafter, it will be described on the assumption that the tonality is A minor. Also, it will be described on the assumption that a MIDI sample is the MIDI sample of FIG. 6.

The music generation apparatus 100 adjusts a pitch of the first note to the component note 700 of the corresponding measure of the audio sample. More specifically, if the pitch of the first note exists in the component note 700, the music generation apparatus 100 maintains the pitch of the first note as it is, and if the pitch of the first note does not exist in the component note 700, the music generation apparatus 100 determines the component note 700 closest to the pitch of the first note as the pitch of the first note.

For example, the pitch of the first note of the first measure 710 of the MIDI sample is C3, the pitch of the first note of the second measure 712 is G3, and the pitch of the first note of the third measure 714 is G3. The music generation apparatus 100 maintains the pitch C3 of the first note of the first measure 710 because the pitch C3 exists in the component note 700. Because the pitch G3 of the first note of the second measure 712 does not exist in the component note 702, F3 or A3, which is the closest component note to G3, is determined as the pitch of the first note of the second measure. The pitch G3 of the first note of the third measure 714 is maintained as it is because the pitch G3 exists in the component note 704. Reference number 720 of FIG. 7 shows the result of adjusting the pitches of notes of the MIDI sample.

The music generation apparatus 100 determines the pitches of the notes from the second note according to whether the notes progress sequentially or jump. First, if the note is sequential with the previous note (i.e., 1 degree difference), and the pitch of the note exists in the component notes 700, 702, and 704, the sequential relationship with the previous note is maintained. Next, if the note is in sequence with the previous note but does not exist in the component notes 700, 702, 704, but exists in the scale note of the tonality (A, B, C, D, E, F, G, A in the case of A minor), the pitch of the note is maintained as it is. If the notes jump instead of progressing sequentially, the music generation apparatus 100 selects a pitch of the component notes 700, 702, and 704 that are closest to the pitches of the notes.

For example, the pitches of the second and subsequent notes of the first measure 710 of the MIDI sample are D3 and E3. D3 is sequential with the first note and does not exist in the component notes 700, but exists in the scale sound, therefore, D3 is maintained as it is. Because E3 is in sequence with the second note and exists in the component note 710, E3 is also maintained.

The pitches of the second and subsequent notes of the second measure 712 of the MIDI sample are A3 and C4. Because A3 is in sequence with the first note and exists in the component note 702, A3 is maintained. However, if the pitch of the first note is changed to F3 (or A3), A3 is changed to G3 (or B3) to become a sequential sound. Because C4 is a jump sound and does not exist in the component note 702, C4 is changed to D4, which is the closest component note 702 to C4.

The pitches of the second and subsequent notes of the third measure 714 of the MIDI sample are E3 and C3. Because E3 is a jump sound and exists in the component note 704, E3 is maintained. Because C3 is a jump sound and does not exist in the component note 704, C3 is changed to B2, which is the closest component note to C3.

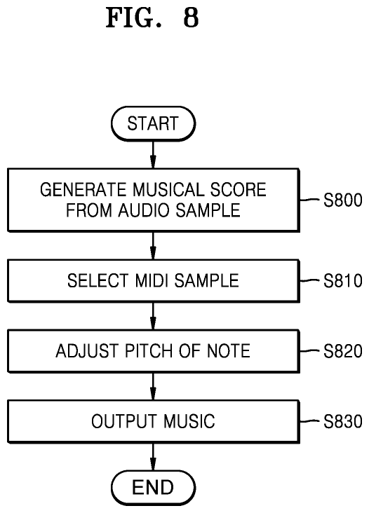

FIG. 8 is a flowchart illustrating an example of a method of generating music according to an embodiment.

Referring to FIG. 8, the music generation apparatus 100 generates a musical score from an audio sample (S800). An example of a method of generating a musical score from an audio sample using an artificial intelligence model is shown in FIGS. 3 and 4.

The music generation apparatus 100 selects a MIDI sample that matches the audio sample based on the position of the note on the time axis (S810). The music generation apparatus 100 may select a MIDI sample including a note at a position that most closely matches the position of the note on the time axis of the audio sample, or select a MIDI sample having a note that does not match the most with the position of the note on the time axis of the audio sample. An example of a method of selecting a MIDI sample suitable for an audio sample is shown in FIG. 5.

The music generation apparatus 100 adjusts the pitch of the note of the selected MIDI sample based on the component notes and tonality of the audio sample (S820). The music generation apparatus 100 moves the notes to positions of notes that match the component notes and tonality of each measure of the audio sample while maintaining an original pitch relationship between the measures of the MIDI sample. Examples of how the music generation apparatus 100 adjusts the pitch of a MIDI sample are shown in FIGS. 6 and 7.

The music generation apparatus 100 outputs a generated melody sample by adjusting the pitch of the MIDI sample (S830). The music generation apparatus 100 may output both a sound of the melody sample and a sound of the audio sample. For example, when the audio sample is an accompaniment part and the MIDI sample is a melody part, the music generation apparatus 100 may select a MIDI sample having a melody that matches the accompaniment of the audio sample, and after adjusting the pitch of the MIDI sample to match the accompaniment, output the MIDI sample along with the sound of the audio sample.

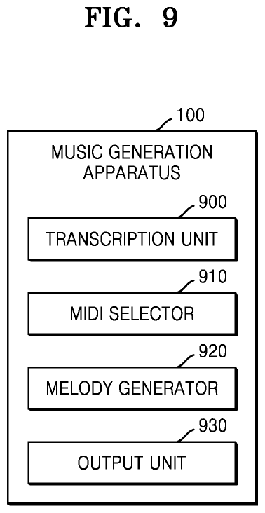

FIG. 9 is a diagram showing a configuration of the music generation apparatus 100 according to an embodiment.

Referring to FIG. 9, the music generation apparatus 100 includes a transcription unit 900, a MIDI selector 910, a melody generator 920, and an output unit 930. The music generation apparatus 100 may be implemented as a computing apparatus including a memory, a processor, and an input/output device. In this case, each configuration may be implemented as software, loaded into a memory, and then executed by a processor.

The transcription unit 900 creates a musical score from an audio sample. The transcription unit 900 may convert an audio sample into a spectrogram and generate a musical score for the audio sample through an artificial intelligence model that outputs musical scores upon receiving the spectrogram. As an example, a method of generating a musical score is shown in FIGS. 3 and 4.

The MIDI selector 910 selects a MIDI sample suitable for a musical score based on the position of a note on the time axis among a plurality of MIDI samples. The MIDI selector 910 may identify the positions of notes on the time axis of the musical score and select MIDI samples configured of notes that match the positions of the notes on the time axis of the musical score or notes that do not match the positions of the notes on the time axis of the musical score.

The melody generator 920 adjusts the pitch of notes of each measure of the selected MIDI sample to match the component notes and tonality of each measure of the musical score of the audio sample. The melody generator 920 includes a component note identifying unit configured to identify a pitch of a component note of a musical score for each measure, a first pitch selector configured to select the pitch of the component note that is the same as or closest to the pitch of the note, a second pitch selector configured to maintain a note in a sequential relationship with the previous note if the note is in sequence with the previous note and the pitch of the note exists in the component note or a scale note corresponding to the component note or the tonality of an audio sample, a third pitch selector configured to select a pitch of the component note closest to a pitch of the note when the note jumps from the previous note. The melody generator 920 may determine a pitch of the first note of each measure of the selected MIDI sample through the first pitch selector and determine the pitch of the second and subsequent notes of each measure through the second pitch selector and the third pitch selector.

The output unit 930 outputs a melody sample in which the pitch of a note is adjusted. As an example, the output unit 930 may combine and output the sound of the melody sample and the audio sample.

The present disclosure may also be implemented as computer readable program codes on a computer readable recording medium. A non-transitory computer-readable recording medium includes all types of recording devices in which data that may be read by a computer system is stored. Examples of non-transitory computer-readable recording media include ROM, RAM, CD-ROM, magnetic tape, floppy disk, and optical data storage devices. In addition, the non-transitory computer-readable recording medium may be distributed to computer systems connected through a network to store and execute computer-readable codes in a distributed manner.

According to an embodiment, music may be generated by automatically combining MIDI samples that match audio samples.

So far, the disclosure has been described mainly with its preferred embodiments. It will be understood by those of ordinary skill in the art that various changes in form and details may be made therein without departing from the spirit and scope of the inventive concept as defined by the appended claims. The embodiments should be considered in descriptive sense only and not for purposes of limitation. Therefore, the scope of the disclosure is defined not by the detailed description of the inventive concept but by the appended claims, and all differences within the scope will be construed as being included in the inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of generating music, the method comprising:
making a musical score from an audio sample;
selecting, from among a plurality of MIDI samples, a musical instrument digital interface (MIDI) sample suitable for the musical score based on a position of a note on a time axis;
adjusting pitches of notes of each measure of the selected MIDI sample to match the component notes and tonality of each measure of the musical score; and
outputting a melody sample in which the pitches of the notes are adjusted.

2. The method of claim 1, wherein the making of the musical score includes:
obtaining a spectrogram of the audio sample; and
generating a musical score for the audio sample through an artificial intelligence model that outputs a musical score when a spectrogram is input thereto.

3. The method of claim 1, wherein the selecting of the MIDI sample includes:
identifying positions of the notes of the musical score on the time axis; and
selecting a MIDI sample including notes that match the positions of the notes on the time axis of the musical score or notes that do not match the positions of the notes on the time axis of the musical score.

4. The method of claim 1, wherein the adjusting of each of the pitches of the notes includes:
identifying the component notes of the musical score for each measure;
selecting a pitch of the component note that is the same as or closest to the pitch of the note for the first note of each measure of the selected MIDI sample;
maintaining the sequential position of the note, for the second and subsequent notes of each measure of the selected MIDI sample, if the note is in sequence with the previous note and the pitch of the note exists in the component note or the scale note corresponding to the tonality of the audio sample; and
selecting a pitch of the component note closest to the pitch of the note when the note jumps from the previous note for the second and subsequent notes of each measure of the selected MIDI sample.

5. The method of claim 1, wherein the outputting of a melody sample includes:
combining the sound of the melody sample with the audio sample; and outputting a combined sound.

6. A music generation apparatus comprising:
a transcription unit configured to create a musical score from an audio sample;
a MIDI selector configured to select, from among a plurality of MIDI samples, a MIDI sample suitable for the musical score based on a position of a time axis of a component note;
a melody generator configured to adjust a pitch of notes of each measure of the selected MIDI sample to match the component note and tonality of each measure of the musical score; and
an output unit configured to output a melody sample in which the pitch of the note is adjusted.

7. The music generation apparatus of claim 6, wherein the transcription unit is further configured to convert the audio sample into a spectrogram and generates a musical score for the audio sample through an artificial intelligence model that outputs a musical score when the spectrogram is input thereto.

8. The music generation apparatus of claim 6, wherein the MIDI selector is further configured to identify the position of the notes on the time axis of the musical score and select a MIDI sample configured of notes that match with the positions of the notes on the time axis of the musical score or notes that do not match with the positions of the notes on the time axis of the musical score.

9. The music generation apparatus of claim 6, wherein the melody generator includes:
a component note identifying unit configured to identify a pitch of component note of the musical score for each measure;
a first pitch selector configured to select a pitch of the component note that is the same as or closest to the pitch of the note;
a second pitch selector configured to maintain the sequential position of the note as it is, if the note is in sequence with the previous note and if the pitch of the note exists in the scale sound corresponding to the component note or the tonality of the audio sample; and
a third pitch selector configured to select a pitch of the component note closest to the pitch of the note when the note jumps from the previous note,
wherein, for the first note of each measure of the selected MIDI sample, the pitch is determined through the first pitch selector, and for the second and subsequent notes of each measure, the pitch is respectively determined through the second pitch selector and the third pitch selector.

10. The music generation apparatus of claim 6, wherein the output unit is further configured to output the melody sample by combining the sound of the melody sample with the audio sample.

11. A non-transitory computer-readable recording medium having recorded thereon a computer program for executing the method of claim 1.

12. A non-transitory computer-readable recording medium having recorded thereon a computer program for executing the method of claim 2.

13. A non-transitory computer-readable recording medium having recorded thereon a computer program for executing the method of claim 3.

14. A non-transitory computer-readable recording medium having recorded thereon a computer program for executing the method of claim 4.

15. A non-transitory computer-readable recording medium having recorded thereon a computer program for executing the method of claim 5.
